(19) United States
(12) Patent Application Publication
(10) Pub. No.: US 2005/0200950 A1
(43) Pub. Date: Sep. 15, 2005

(54) Projection screen and lens thereof

(76) Inventors: Chyun-Yu Lin, Taipei Hsien (TW); Shao Chin Lu, Taipei Hsien (TW); Chun Chi Cheng, Taipei Hsien (TW); Jey Sheng Lin, Taipei Hsien (TW); Yi Ting Li, Taipei Hsien (TW)

Correspondence Address: BIRCH STEWART KOLASCH & BIRCH, PO BOX 747, FALLS CHURCH, VA, 22040-0747, US

(21) Appl. No.: 10/872,392

(22) Filed: Jun. 22, 2004

(30) Foreign Application Priority Data
Mar. 12, 2004 (TW) 093106769

(51) Int. Cl. G03B 21/56

(52) U.S. Cl. 359/443

(57) ABSTRACT

A screen lens including a polymer film and a lens layer. The lens layer is stuck on a side of the polymer. The material of the polymer is chosen from the group consisting of polyethylene terephthalate, triacetyl cellulose, polystyrene, polypropylene, polyethylene, polyvinylchloride, polycarbonate and polyurethane. The material of the lens layer is chosen from the group consisting of light-sensitive glue, pressure-sensitive glue, room temperature forming glue, heat forming glue and anaerobic glue.

### BACKGROUND OF THE INVENTION

1. Field of Invention

The invention relates to a screen lens and, in particular, to a screen lens comprising a polymer film.

2. Related Art

As the progress of technology, people have more demands in monitor quality, such as large screen size, higher definition, lighter and thinner. The monitor with the above-mentioned quality is future tendency, so the components for the monitor must meet the needs. The screen lens is one of those components.

Taking a Fresnel lens for example, referring to FIG. 1 and FIG. 2, a Fresnel lens 1 comprises a transparent acrylic plate 11 and a lens layer 12 with a Fresnel pattern. The thickness of the transparent acrylic plate 11 ranges from 0.7 mm to 3 mm.

The manufacturing processes of the lens layer 12 include the following steps. First, light forming glue is applied to a Fresnel mould 2. Then, the transparent acrylic plate 11 is disposed on the light forming glue by way of a rolling-press method, so as to make the light forming glue equally applied between the Fresnel mould and the transparent acrylic plate 11. The light forming glue can be ultraviolet light glue consisting of methyl acrylate and polyurethane, such as Everwide Chemical acrylic ultraviolet glue EXA288, and a photo initiator Ciba E-184 (0.5-5%) is used in this case.

The stacked transparent acrylic plate 11, light forming glue and Fresnel mould 2 are transferred into an exposure zone, so as to project a light onto the stacked structure. Thus, the light forming glue is solidified to form the desired lens layer 12 with the Fresnel pattern. In such a case, the lens layer 12 is adhered to the transparent acrylic plate 11. The projected light for curing the glue can be an ultraviolet light.

After the lens layer 12 is formed and adhered to the transparent acrylic plate 11, the transparent acrylic plate 11 and lens layer 12 are separated from the Fresnel mould 2. A Fresnel lens 1 is then obtained.

With reference to FIG. 3, in order to make the Fresnel lens 1 attach firmly to the diffusing plate and not to produce any twist image and image barrier, an additional baking process is usually performed before the step of attaching the Fresnel lens 1 to the diffusing plate. Alternatively, the rigidity of the transparent acrylic plate 11 can be increased to solve the above-mentioned problems. However, the transparent acrylic plate 11 is not definitely attached firmly to the diffusing plate only by the baking process. Furthermore, the increased rigidity makes the transparent acrylic plate 11 more easily to be broken during the rolling-press process or the separating process, resulting in the decrease of the production yield. In addition, the heavy weight of the large-sized Fresnel lens 1 made of the transparent acrylic plate 11 dose not meet the public needs.

It is therefore a subjective of the invention to provide a screen lens, which has high production yield and is lighter and thinner.

### SUMMARY OF THE INVENTION

In view of the above-mentioned subjective, the invention is to provide a screen lens comprising a polymer film.

To achieve the above, a screen lens of the invention comprises a polymer film and a lens layer. In the invention, the lens layer is adhered to one side of the polymer film.

The polymer film is made of a material selected from the group consisting of polyethylene terephthalate, triacetyl cellulose, polystyrene, polypropylene, polyethylene, polyvinylchloride, polycarbonate and polyurethane. The lens layer is made of a material selected from the group consisting of light-sensitive glue, pressure-sensitive glue, room temperature forming glue, heat forming glue and anaerobic glue.

As mentioned above, since the screen lens of the invention is manufactured by utilizing the polymer film, the screen lens of this invention can be lighter, thinner, and have better transparency and lower cost than the conventional screen lens.

### BRIEF DESCRIPTION OF THE DRAWINGS

The invention will become more fully understood from the detailed description given hereinbelow illustration only, and thus is not limitative of the present invention, and wherein:

FIG. 1 is a schematic illustration showing a conventional Fresnel lens;

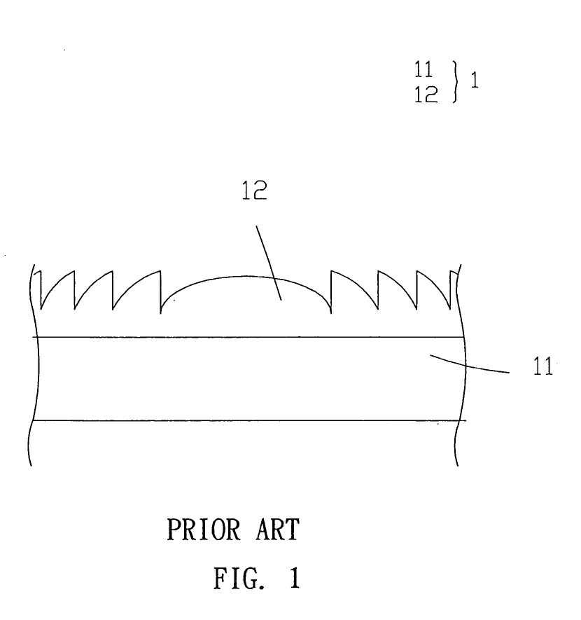

FIG. 2 is a schematic illustration showing the rolling process of the conventional Fresnel lens;

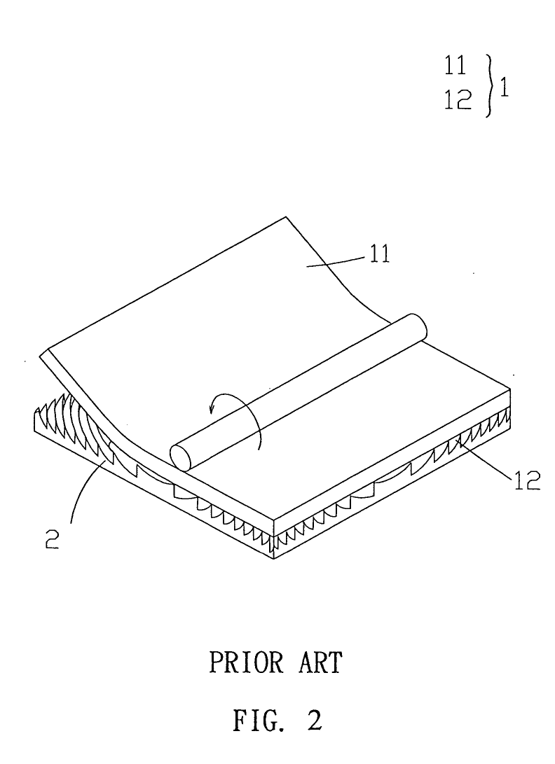

FIG. 3 is a schematic illustration showing the separating process of the conventional Fresnel lens from the mould;

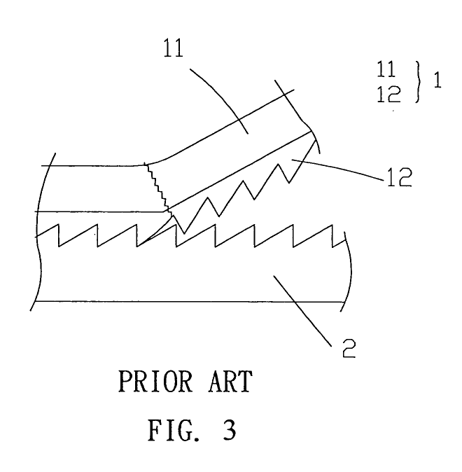

FIG. 4 is a sectional view showing a Fresnel lens according to an embodiment of the invention; and

FIG. 5 is a cross-sectional view showing a projection screen according to an embodiment of the invention.

### DETAILED DESCRIPTION OF THE INVENTION

The present invention will be apparent from the following detailed description, which proceeds with reference to the accompanying drawings, wherein the same references relate to the same elements.

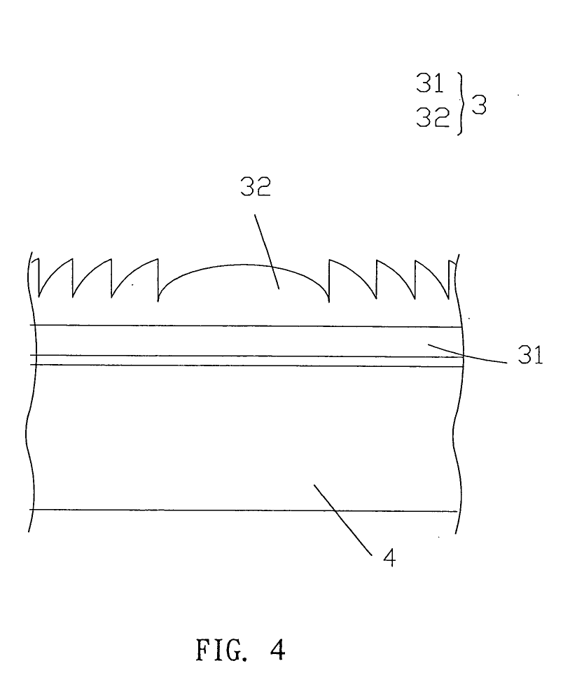

To make the invention easier to be illustrated, the following description takes a Fresnel lens for example. Referring to FIG.4, a Fresnel lens 3 according to an embodiment of the invention comprises a polymer film 31 and a lens layer 32.

The thickness of the polymer film 31 ranges from 0.05 mm to 0.5 mm. The polymer film 31 is made of a material selected from the group consisting of polyethylene terephthalate, triacetyl cellulose, polystyrene, polypropylene, polyethylene, polyvinylchloride, polycarbonate and polyurethane. In the embodiment, the polymer film 31 is made of terephthalate.

The lens layer 32 is adhered on a side of the polymer film 31 and is made of lens forming glue selected from the group consisting of light-sensitive glue, pressure-sensitive glue, room temperature forming glue, heat forming glue and anaerobic glue. The light-sensitive glue contains polymethyl methacrylate. The room temperature forming glue contains the material selected from the group consisting of polyvinyl acetate and unsaturated polyester. The heat forming glue contains the material selected from the group consisting of rubber, ethylene/vinyl acetate, epoxy, and silicone rubber. In the present embodiment, an Everwide Chemical Acrylic Ultraviolet glue EXA953 is used and a photo initiator Ciba E-184 (0.5-5%) is used together for the glue EXA953.

In practice, the Fresnel lens 3 is adhered to a high rigid transparent substrate 4, such as glass or acrylic plate. Wherein, another side of the polymer film 31 of the Fresnel lens 3 is attached to the transparent substrate 4.

In this embodiment, the Fresnel lens 3 comprises the polymer film 31 having good flexibility, so the Fresnel lens 3 is not easily broken during the rolling process or separating process. Therefore, the production yield can be increased. In practice, the Fresnel lens 3 is pasted firmly to the transparent substrate 4 with another side of the polymer film 31, so it can increase the rigidity after assembling with the diffusing plate. Thus, the twist image and image barrier due to the deformation of the monitor lens can be avoided.

Besides, the Fresnel lens 3 of this embodiment has a thickness thinner and lighter than that of the conventional Fresnel lens. Therefore, the Fresnel lens 3 can be wrapped into smaller volume. The wrapped Fresnel lens 3 has advantages for shipping, and it can thus lower the transportation cost.

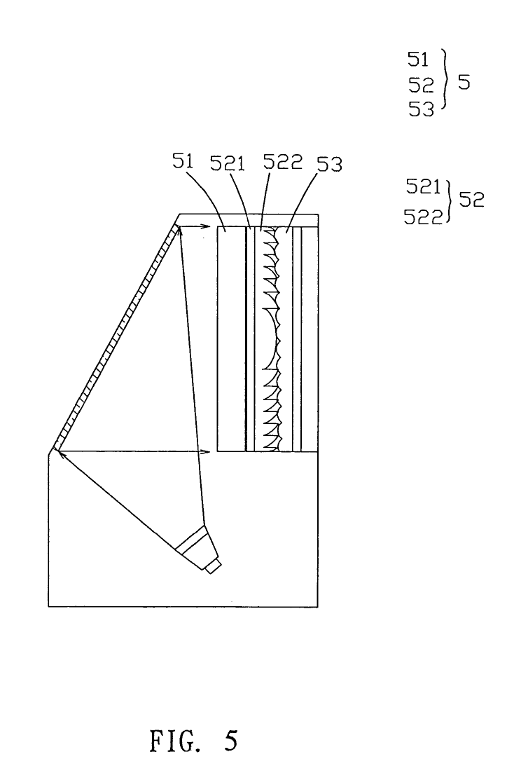

Referring to FIG. 5, a projection screen 5 according to the embodiment of the invention comprises a transparent substrate 51, a Fresnel lens 52 and a diffusing plate 53.

The transparent substrate 51 is a rigid substrate. In this embodiment, the transparent substrate 51 can be an acrylic plate or a glass plate.

The Fresnel lens 52 is adhered to the transparent substrate 52 and comprises a polymer film 521 and a lens layer 522. The polymer film 521 is made of a material selected from the group consisting of polyethylene terephthalate, triacetyl cellulose, polystyrene, polypropylene, polyethylene, polyvinylchloride, polycarbonate and polyurethane. The lens layer 522 is made of a material selected from the group consisting of light-sensitive glue, pressure-sensitive glue, room temperature forming glue, heat forming glue and anaerobic glue. While the lens layer 522 is adhered to a side of the polymer film 521, the other side of the polymer film 521 is adhered tightly to the transparent substrate 51.

The diffusing plate 53 is disposed on the Fresnel lens 52.

In this embodiment, the material, the arrangement and the functions of the Fresnel lens 52, the polymer film 521 and the lens layer 522 are the same as the previous mentioned Fresnel lens 3, and the descriptions thereof are omitted.

As mentioned above, the screen lens (such as the Fresnel lens) of the invention is made of a polymer film having good flexibility, so the production yield can be improved. In practice, another side of the polymer film of the screen lens is adhered to a transparent substrate. Therefore, it can increase the rigidity of the screen lens after assembling with the diffusing plate, so as to avoid of twist image and image barrier due to the deformation of the screen lens.

Moreover, the screen lens (such as the Fresnel lens) of the invention is thinner and lighter than the conventional screen lens. Thus, the screen lens can be wrapped into smaller volume. The wrapped screen lens occupies smaller space, so that it is suitable for shipping and can thus lower the transportation cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the tale scope of the invention.

1. A screen lens, comprising:
a polymer film, which is made of a material selected from the group consisting of polyethylene terephthalate, triacetyl cellulose, polystyrene, polypropylene, polyethylene, polyvinylchloride, polycarbonate and polyurethane; and
a lens layer, which is adhered on a side of the polymer film and is made of a material selected from the group consisting of light-sensitive glue, pressure-sensitive glue, room temperature forming glue, heat forming glue and anaerobic glue.

2. The screen lens of claim 1, wherein the light-sensitive glue comprises polymethyl methacrylate.

3. The screen lens of claim 1, wherein the room temperature forming glue is made of the material selected from the group consisting of polyvinyl acetate and unsaturated polyester.

4. The screen lens of claim 1, wherein the heat forming glue is made of the material selected from the group consisting of rubber, ethylene/ vinyl acetate, epoxy, and silicone rubber.

5. The screen lens of claim 1, wherein the thickness of the polymer film ranges from 0.05 mm to 0.5 mm.

6. The screen lens of claim 1, wherein the other side of the polymer film is adhered to a transparent substrate.

7. The screen lens of claim 6, wherein the transparent substrate is an acrylic plate.

8. The screen lens of claim 6, wherein the transparent substrate is a glass plate.

9. A projection screen, comprising:
a transparent substrate; and
a screen lens, which is adhered to the transparent substrate, and comprises:
a polymer film, which is made of a material selected from the group consisting of polyethylene terephthalate, triacetyl cellulose, polystyrene, polypropylene, polyethylene, polyvinylchloride, polycarbonate and polyurethane, and
a lens layer, which is adhered on a side of the polymer film and is made of a material selected from the group consisting of light-sensitive glue, pressure-sensitive glue, room temperature forming glue, heat forming glue and anaerobic glue.

10. The projection screen of claim 9, wherein the light-sensitive glue comprises polymethyl methacrylate.

11. The projection screen of claim 9, wherein the room temperature forming glue is made of the material selected from the group consisting of polyvinyl acetate and unsaturated polyester.

12. The projection screen of claim 9, wherein the heat forming glue is made of the material selected from the group consisting of rubber, ethylene/ vinyl acetate, epoxy, and silicone rubber.

13. The projection screen of claim 9, wherein the thickness of the polymer film ranges from 0.05 mm to 0.5 mm.

14. The projection screen of claim 9, wherein the other side of the polymer film is adhered to a transparent substrate.

15. The projection screen of claim 9, wherein the transparent substrate is an acrylic plate.

16. The projection screen of claim 9, wherein the transparent substrate is a glass plate.

17. The projection screen of claim 9, further comprising:
a diffusing plate, which is connected to the projection screen.
